(19) United States
(12) Patent Application Publication
(10) Pub. No.: US 2012/0302244 A1
(43) Pub. Date: Nov. 29, 2012

(54) Influencing Load Balancing Between Radio Access Technologies

(75) Inventors: Kamakshi Sridhar, Plano, TX (US); Peter Busschbach, Basking Ridge, NJ (US); Kevin Sparks, North Andover, MA (US); Alistair Urie, Issy-Les Moulineaux (FR)

(73) Assignees: ALCATEL-LUCENT, Paris (FR); ALCATEL-LUCENT USA INC., Murray Hill, NJ (US)

(21) Appl. No.: 13/115,480

(22) Filed: May 25, 2011

(51) Int. Cl. H04W 36/22; H04W 36/36

(52) U.S. Cl. 455/438; 455/436

(57) ABSTRACT

One embodiment of the method includes transferring, by a network element, a user equipment to a different one of the plurality of RATs based on a load balancing determination and a profile for the user equipment. The profile indicates a preference for each of the plurality of RATs, and at least one of the preferences is based on at least one attribute of the user equipment monitored over a period of time.

### BACKGROUND OF THE INVENTION

In heterogeneous layered networks, where operators have deployed 2G, 3G (UMTS or CDMA) and/or LTE carriers in a given region, the radio access network (RAN) load balancing algorithms have to decide the best radio access technology (RAT) (e.g., 2G, 3G or LTE) to which user equipments (UEs) should be load balanced when there is a trigger for load balancing. Triggers for load balancing include conditions such as a crossover of RAN load thresholds, alarm and call admission control (CAC) failure conditions etc.

For active UEs, load balancing between 3G carriers and between 3G and 4G carriers is done based on current radio resource measurements and cell loads on each carrier. For idle mode UEs, choice of RAT is done through idle mode redirection in a predetermined static manner. 3GPP has provided for standardized load balancing mechanisms through the exchange of RIM messages (RAN information messages). However, 3GPP's standards assume that load balancing is only based on the current loading of the respective air interfaces, where all UEs are being treated as equal.

### SUMMARY

At least some example embodiments relate to a method of influencing load balancing among a plurality of radio access technologies (RATs).

One embodiment of the method includes transferring, by a network element, a user equipment to a different one of the plurality of RATs based on a load balancing determination and a profile for the user equipment. The profile indicates a preference for each of the plurality of RATs, and at least one of the preferences is based on at least one attribute of the user equipment monitored over a period of time.

In one embodiment, the transferring includes determining whether to transfer the user equipment to a different one the of plurality or RATs and determining the different RAT to which to transfer the user equipment based on the profile if the load balancing determination indicates to perform load balancing.

In one embodiment, the attribute is one of bearer usage over the period of time and signaling usage over the period of time.

In one embodiment, at least one of the preferences is based on a cost function, and the cost function is based on the attribute.

In another embodiment, at least one of the preferences is accessed from a look-up table using the attribute.

In one embodiment, the transferring transfers the user equipment to a different carrier based on the profile. Here, the profile further indicates a preference for each of a plurality of carriers in at least the different RAT.

Another embodiment further includes transferring the load balancing profile from a serving base station, which severs the user equipment, to a target base station if the user equipment is handed over to the target base station.

At least some embodiments relate to method of influencing load balancing among a plurality of radio access technologies (RATs).

One embodiment of this method includes influencing, at a network element, a RAT selected from among the plurality of RATs for a user equipment based on historical operation of the user equipment if load balancing is triggered.

At least some embodiments are related to a method of generating a load balancing profile for a user equipment.

In one embodiment, the method includes monitoring, at a network element, at least one attribute of a user equipment over a period of time; generating preference values for the plurality of RATs, at least one of the preference values being based on the monitored attribute; and generating the load balancing profile based on the generated preference values.

In one embodiment, the monitored attribute is one of bearer usage over the period of time and signaling usage over the period of time.

In one embodiment, the generating preference values generates at least one of the preference values based on a cost function, and the cost function is based on the monitored attribute.

In one embodiment, the generating preference values generates at least one of the preference values by accessing a look-up table using the monitored attribute.

In one embodiment, the generating preference values generates preference values for carriers of at least one of the plurality of RATs.

The method may further include storing the load balancing profile in a home serving system.

The method may further include transferring the load balancing profile to a base station, and performing, at the base station, load balancing based on the load balancing profile.

At least some embodiments relate to a communication network.

In one embodiment, a core network element is configured to receive at least one attribute of a user equipment over a period of time, and is configured to generate preference values for a plurality of radio access technologies (RATs), at least one preference value being based on the received attribute. The core network element is configured to generate a load balancing profile based on the generated preference values.

In one embodiment, the core network element is a policy and charging rules function configured to generate the load balancing profile based on the generated preference values.

In another embodiment, the core network element is a policy and charging rules function configured to generate the load balancing profile by accessing a look-up table using the monitored attribute.

### BRIEF DESCRIPTION OF THE DRAWINGS

The example embodiments will become more fully understood from the detailed description given herein below and the accompanying drawings, wherein like elements are represented by like reference numerals, which are given by way of illustration only and thus are not limiting of the example embodiments and wherein:

FIG. 1 illustrates a network architecture supporting multiple radio access technologies (RATs).

FIG. 2 illustrates a flow chart of a method of generating RAT preference values for user equipment (UE) according to an embodiment.

FIG. 3 illustrates a flow chart of a method of generating a load balancing profile for a UE according to an embodiment.

FIG. 4 illustrates a flow chart of a method of influencing load balancing based on the load balancing profile according to an embodiment.

FIG. 5 illustrates an example load balancing profile.

FIG. 6 illustrates a flow chart of a method of generating attribute information for user equipment (UE) according to an embodiment.

FIG. 7 illustrates a flow chart of a method of mapping attribute information for a UE to a load balancing profile for the UE according to an embodiment.

FIG. 8 illustrates one example of a look-up table used in the method of FIG. 7.

### DETAILED DESCRIPTION OF THE EMBODIMENTS

Detailed illustrative embodiments are disclosed herein. However, specific structural and functional details disclosed herein are merely representative for purposes of describing example embodiments. An embodiment may, however, be embodied in many alternate forms and should not be construed as limited to only the embodiments set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

Exemplary embodiments are discussed herein as being implemented in a suitable computing environment. Although not required, exemplary embodiments will be described in the general context of computer-executable instructions, such as sections, program modules or functional processes, being executed by one or more computer processors or CPUs. Generally, sections, program modules or functional processes include routines, programs, objects, components, data structures, etc. that performs particular tasks or implement particular abstract data types in conjunction with associated hardware on which the program modules/functional processes are implemented. The sections, program modules and functional processes discussed herein may be implemented using existing hardware in existing communication networks. For example, sections, program modules and functional processes discussed herein may be implemented using existing hardware at existing network elements, servers or control nodes. Such existing hardware may include one or more digital signal processors (DSPs), application-specific-integrated-circuits, field programmable gate arrays (FPGAs) computers or the like.

In the following description, illustrative embodiments will be described with reference to acts and symbolic representations of operations (e.g., in the form of flowcharts) that are performed by one or more processors, unless indicated otherwise. As such, it will be understood that such acts and operations, which are at times referred to as being computer-executed, include the manipulation by the processor of electrical signals representing data in a structured form. This manipulation transforms the data or maintains it at locations in the memory system of the computer, which reconfigures or otherwise alters the operation of the computer in a manner well understood by those skilled in the art,

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

As used herein, the term “user equipment (UE)” may be considered synonymous to, and may hereafter be occasionally referred to, as a mobile, mobile unit, mobile station, mobile user, access terminal (AT), subscriber, user, remote station, receiver, etc., and may describe a remote user of wireless resources in a wireless communication network. The term “base station (BS)” may be considered synonymous to and/or referred to as a base transceiver station (BTS), NodeB, access node (AN), eNodeB, etc. and may describe equipment that provides data and/or voice connectivity between a network and one or more users.

As is well-known in the art, each of the user equipment and the base station may have transmission and reception capabilities. Transmission from the base station to the UE is referred to as downlink or forward link communication. Transmission from the UE to the base station is referred to as uplink or reverse link communication.

At least some embodiments define a load balancing profile (LB profile) for a given UE that ranks the potential RATs based on information collected within the core network such as historical data usage, subscriber profile, device type and application usage. When the normal or conventional load balancing triggers are exercised, this load balancing profile for the UE is utilized as additional input besides the RAN load to decide which UEs need to be load balanced to which RAT. In cases where there are small cells deployed in addition to macro cells, the load balancing profile is extended to include the ranking per carrier for a given RAT. The load balancing profiles may be updated on a slower time scale as compared to the frequency of the RAN load balancing algorithms that will use this profile.

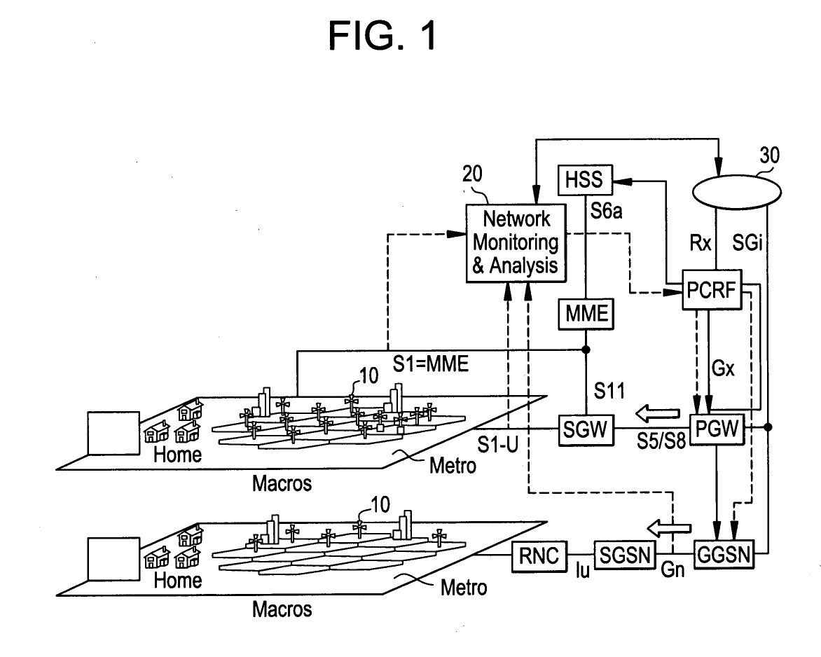

FIG. 1 illustrates a portion of a network architecture supporting multiple radio access technologies. As shown, the network architecture supports two RATs, an LTE RAN and a 3G RAN. Each of the LTE RAN and the 3G RAN serves a same geographic area divided into cells, where the UEs in each cell are served by a respective base station 10. The core network associated with the RANs includes a radio network control RNC configured to communicate with the base stations 10 of the 3G RAN. A serving gateway support node SGSN communicates with the radio access network RNC over an Iu interface and communicates with a gateway general support node GGSN over a Gn interface. While not shown the gateway general support node GGSN may communicate with other networks such as the internet.

The core network associated with the RANs also includes a signaling gateway SGW configured to communicate with the base stations 10 of the LTE RAN via S1-u interfaces. A packet data network gateway PGW communicates with the signaling gateway SGW, and while not shown may communicate with other networks such as the internet. A mobility management entity MME may also communicate with the base stations 10 of the LTE RAN via a S1-MME interface, and the MME also communicates with the signaling gateway SGW via a S11 interface. It will be appreciated that the network architecture may include more than one RNC, SGW, etc. and additional base stations 10 associated with the additional core network resources to serve a larger geographic area.

A policy and charging rules function PCRF communicates with both the packet data network gateway PGW and the gateway general support node GGSN via a Gx interface. According to at least one embodiment, the policy and charging rules function PCRF also communicates with a home subscriber server HSS, and the home subscriber server HSS further communicates with the mobility management entity MME.

As further shown, the network architecture includes a network monitoring and analysis (NMA) unit 20. The NMA unit 20 tracks a set of attributes for each UE. For example, the NMA unit 20 monitors traffic (signaling and bearer) on the network interfaces such as the S1-MME interface, the S1-U interface and the Gn interface. In at least some embodiments, the attributes include a historical view of voice and/or data (both signaling and bearer) usage of the UE, mobility of the UE, device type of the UE (e.g., manufacturer and model of the UE), applications run and/or application types (e.g., delay sensitive, delay insensitive, etc.) run by the UE, loading on the control plane, etc. The NMA unit 20 gathers this attribute information using any well-known central monitoring tool and any well-known deep packet inspection (DPI) based detection solution.

Operators 30 of the network communicate with the NMA unit 20 as well as the policy and charging rules function PCRF, packet data network gateway PGW and gateway general support node GGSN to monitor and control network operations.

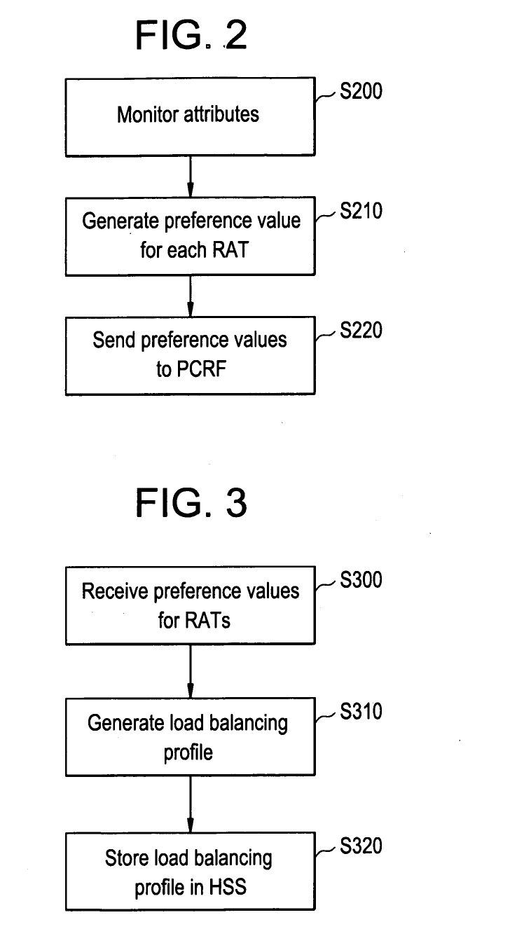

Next, generation of a load balancing profile and load balancing based on the load balancing profile will be described below with respect to FIGS. 2-5.

FIG. 2 illustrates a flow chart of a method of generating RAT preference values for a UE. As shown, in step S200, the NMA unit 20 monitors attributes of the UE. The attributes may be associated with an identifier of the UE. For example, the identifier may be a device identifier, a subscriber identifier, etc. As discussed above, the attributes may include a historical view of voice and/or data (both signaling and bearer) usage of the UE, mobility of the UE, device type of the UE (e.g., manufacturer and model of UE), applications run and/or application types (e.g., delay sensitive, delay insensitive, etc.) run by the UE, loading on the control plane, etc.

For example, the historical view of data usage may be bearer usage over a time window and signaling usage of the same or a different time window. The time window may be any amount of time that provides a historical view of the data usage such as 6 hours, 12 hours, 24 hours, etc. The historical view of voice usage may be determined in the same manner.

The attribute value of mobility may be determined using the following table:

TABLE 1
Mobility

| | |
|---|---|
| Static last 24 hours | 1 |
| Moving last 24 hours | 5 |

It will be appreciated that the time window for determining mobility may be less than the 24 hours as shown in Table 1. Also, it will be appreciated that more than one level of mobility may be provided. Namely, the number of mobility levels and the values assigned to each level, including static, are design parameters that may be developed and updated through empirical study. In one embodiment, Table 1 is supplied to and/or updated at the NMA unit 20 by the operators 30.

The attribute value of device type may be determined using Table 2 shown below:

TABLE 2
Device Type

| | |
|---|---|
| Company A phone 1 | 1 |
| Company A phone 2 | 2 |
| Company B phone | 3 |
| Company C phone | 4 |
| Company B tablet | 5 |
| Company D phone | 6 |

As with Table 1 above, the number of entries in Table 2 and the values assigned to each entry are design parameters and may be developed and updated through empirical study. Also, Table 2 may be supplied to and/or updated at the NMA unit 20 by the operators 30.

The attribute value of application type may be determined using Table 3 shown below:

TABLE 3
Application Type

| | |
|---|---|
| Email | 2 |
| Web browsing | 4 |
| Voice | 6 |
| Real time video | 8 |
| Non RT video | 10 |
| Specific Web Site A | 12 |

As with Table 2 above, the number of entries in Table 3 and the values assigned to each entry are design parameters and may be developed and updated through empirical study. Also, Table 3 may be supplied to and/or updated at the NMA unit 20 by the operators 30.

In step S210, the NMA unit 20 generates a RAT preference value for each of the RATs based on one or more of the attributes for the UE. In one embodiment, an RAT preference value is generated using a cost function. For example, the cost function may weight a number of the attributes, and determine the preference value as the sum of selected weighted and un-weighted attributes. The weights themselves may be design parameters and may be developed and updated through empirical study. Also, the weights may be supplied to and/or updated at the NMA unit 20 by the operators 30.

The equation below shows an example cost function for determining a preference value (PV) for each RAT:

$$PV = ( A 1 / ( bearer usage on the RAT over the last 24 hours + K 1 ) ) + ( A 2 / ( signal usage on the RAT over the last 24 hours + K 2 ) ) + A 3 * Device Type Attribute Value from Table 2 + A 4 * Highest Application Type Attribute Value from Table 3$$

where A1-A4 are the weights discussed above, and K1 and K2 are non-zero value (e.g., 1000 Mps) to prevent division by zero.

The NMA unit 20 then sends the determined preference values to the policy and charging rules function PCRF in step S220 along with an identifier of the UE. It will be appreciated that the NMA unit 20 may generate the preference values periodically (e.g., daily, hourly, etc.), or the NMA unit 20 may by triggered to generate the preference values. For example, the operators 30 may instruct the generation of the preference values, or the occurrence of some event detected by the NMA unit 20 may trigger generation of the preference values.

Next, generation of a load balancing profile will be described with respect to FIG. 3. In step S300, the policy and charging rules function PCRF receives the preference values from the NMA unit 20. The policy and charging rules function PCRF associates the preference values of a UE with a UE identifier in step S310 to generate the load balancing profile. The UE identifier may be device identifier, a subscriber identifier, etc. and may be the same identifier received from the NMA unit 20.

FIG. 5 illustrates an example load balancing profile. As shown, for an example UE, a preference value of 5 is associated with the 3G RAT and a preference value of 3 is associated with the LTE RAT. In step S320, the policy and charging rules function PCRF stores the load balancing profile in the home subscriber server HSS.

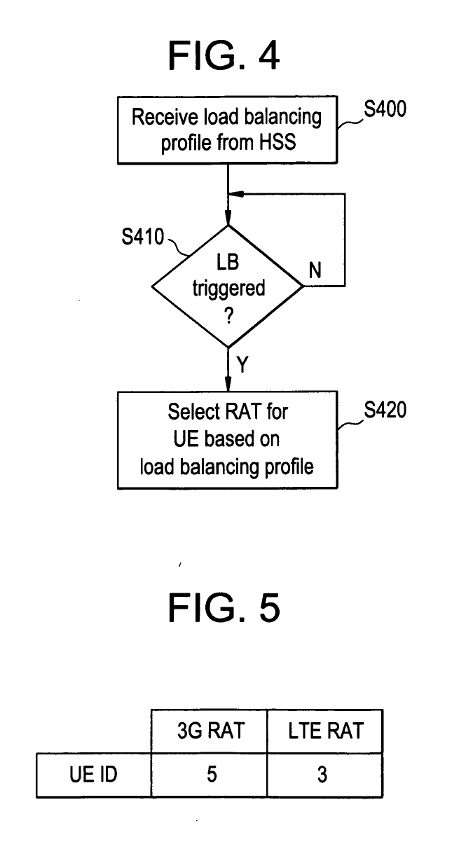

Next, load balancing based on the load balancing profile will be described with respect to FIG. 4. As shown, in step S400, a base station 10 in any of the RAN receives load balancing profiles from the home serving system HSS for the UEs for which the base station 10 is the serving base station (e.g., providing or expected to provide communication services to a UE). In step S410, the base station 10 determines whether load balancing has been triggered. Namely, the base station 10 will operate according to any well-known load balancing technique to determine whether load balancing should take place. As is well-known, this determination may be based on real-time measurements of air interface loading and congestion. Load balancing between 3G and LTE, for example, may be accomplished with existing 3GPP standardized mechanisms (e.g., RIM-RAN Information Monitoring).

If the determination in step S410 is positive, then in step S420, the base station 10 selects a RAT for UEs based on the load balancing profile. For example, if the 3G RAT is overloaded, those UEs having a higher preference value for the LTE RAT, as indicated by their load balancing profiles, may be moved to the LTE RAT. By contrast, those UEs having a higher preference value for the 3G RAT may be kept on the 3G RAT. If this does not provide for acceptable load levels, then conventional methods of distributing load may then be invoked.

Accordingly, all UEs are not necessarily redirected. Instead, some UEs are redirected before others based on preferences contained in the load balancing profile, in combination with the traditional radio signal quality metrics, but only if it is determined that the load on the cell for a particular RAT should be reduced.

Still further, handing a UE over to LTE (or 3G) may be made sticky to prevent ping ponging by introducing hysteresis.

Returning to step S410, if the determination is negative, then processing continues to loop at step S410.

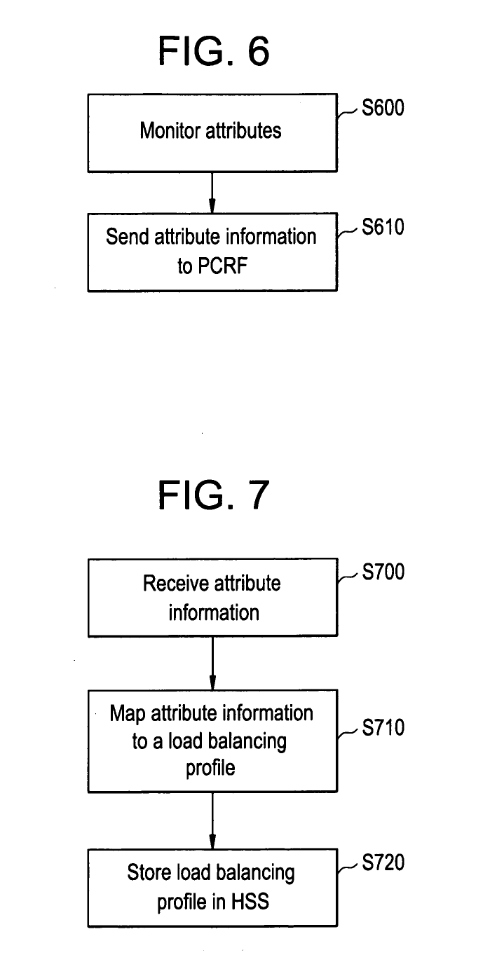

Next, generation of load balancing profile according to another embodiment will be described below with respect to FIGS. 6-7. FIG. 6 illustrates a flow chart of a method of generating attribute information for user equipment (UE) according to an embodiment. As shown, in step S600, the NMA unit 20 monitors attributes of the UE. Operation of step S600 may be the same as step S200 described above. Accordingly, for the sake of brevity, a description of this step will not be repeated.

The NMA unit 20 sends the attribute information to the policy and charging rules function PCRF in step S610 along with an identifier of the UE. The UE identifier may be device identifier, a subscriber identifier, etc. and may be the same identifier received from the NMA unit 20. It will be appreciated that the NMA unit 20 may send the attribute information periodically (e.g., daily, hourly, etc.), or the NMA unit 20 may by triggered to send the attribute information. For example, the operators 30 may instruct sending the attribute information, or the occurrence of some event detected by the NMA unit 20 may trigger sending the attribute information.

Next, generation of a load balancing profile will be described with respect to FIG. 7. In step S700, the policy and charging rules function PCRF receives the attribute information from the NMA unit 20. The policy and charging rules function includes at least a processor and a memory. The policy and charging rules function PCRF, in step S710, maps the attribute information to a load balancing profile. In particular, certain attribute information may first be mapped to an attribute level, and the attribute levels are then applied to a look-up table, which outputs the preference values of a load balancing profile. The examples of signaling usage and bearer usage will be described. As discussed above, signaling usage and bearer usage may be measured values over a period time (e.g., 6 hours, daily, weekly, monthly, etc.). Further, according to one embodiment, usage may be expressed as a percentage. For example, the NMA unit 20 may generate the following attributes for a UE:

VS=signaling volume (messages) as a percentage of average UE signaling volume (for UEs monitored by the NMA unit 20),

VD=total UE bearer volume (MB) as a percentage of average UE bearer volume (for UEs monitored by the NMA unit 20),

VR=UE real time (RT) bearer volume as percentage of UE total bearer volume.

These attributes may then be classified into attribute levels based on thresholds associated with each attribute. The thresholds associated with each attribute are design parameters that may be developed and updated through empirical study. In one embodiment, at least some of the thresholds are supplied to and/or updated at the policy and charging function PCRF by the operators 30. For example, signaling usage may be classified as follows assuming thresholds S1, S2, where S1>S2:

If VS>S1, UE signaling usage is “High”

If Si>VS>S2, UE signaling usage is “Med”

If VS<S2, UE signaling usage is “Low”

Signaling volume equal to a threshold value (e.g. VS=S1) may fall into a classification (e.g. “High” or “Med”) based on design parameters.

Bearer usage may be classified into a real time bearer usage level or non-real time bearer usage level. A real-time threshold M may be used for this purpose. For example, if VR/VD is greater than M, then the bearer usage is classified into a real time bearer usage level, and if VR/VD is less than or equal to M, then the bearer usage is classified into a non-real time bearer usage level. Classification into a particular level may take place as follows assuming thresholds D1, D2, D3 where D1>D2>D3:

If VD>D1, bearer usage=“High” (“High/RT” if VR/VD>M)

If D1>=VD>=D2, bearer usage=“Med” (“Med/RT” if VR/VD>M)

If D2>=VD>=D3, bearer usage=“Low” (“Low/RT” if VR/VD>M)

If VD<D3, bearer usage is negligible=“Voice only”

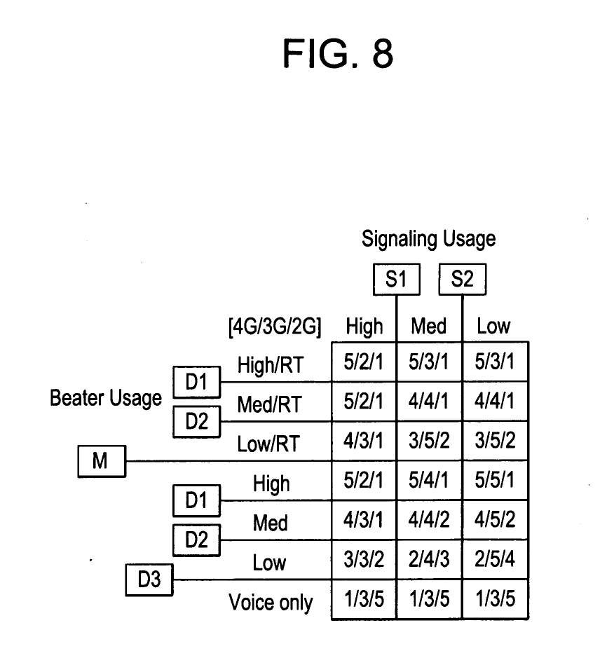

Having classified attributes into attribute levels, the policy and charging function PCRF accesses a look-up table using the attribute levels to obtain a load balancing profile for the UE. The table shown in FIG. 8 illustrates one example of such a look-up table. As shown, the look-up table provides the preference value for each RAT for a signaling usage level and a bearer usage level pair. For example, if bearer usage is classified as real-time and medium, and signaling usage is high, then the preferences values for the RATs of 4G, 3G and 2G would be 5, 2 and 1, respectively. The policy and charging rules function PCRF associates the preference values with a UE identifier to generate the load balancing profile. The UE identifier may be a device identifier, a subscriber identifier, etc. and may be the same identifier received from the NMA unit 20. The load balancing profile may be as described above with respect to FIG. 5. In step S720, the policy and charging rules function PCRF stores the load balancing profile in the home subscriber server HSS.

While obtaining the preference values was described using the attributes of signaling usage and bearer usage, a different combination of attributes may be used to map attributes to preference values of a load balancing profile. For example, in one embodiment additional attributes may be used. In this embodiment, one or more of the thresholds M, S, and/or D may be accessed from a look-up table based on device type and/or application type. Still further, a plurality of different look-up tables may be provided, and the look-up table used in Step S710 may be selected using the attributes device type and/application type. As a still further example, look-up tables not based on signaling usage and/or bearer usage may also be developed.

Each look-up table, and more specifically, the preference values populating the look-up table, are design parameters that may be developed and updated through empirical study. In one embodiment, the look-up table or preference values therein are supplied to and/or updated at the policy and charging function by the operators 30.

With respect to the embodiment of FIGS. 6-7, load balancing based on the load balancing profile may be performed in the same manner described above with respect to FIG. 4.

In any of the above embodiments, if the UE is transferred or handed off from a serving base station to a target base station, then the serving base station may send the load balancing profile for the UE to the target base station.

While embodiments were described above using only two or three RATs in a network, the embodiments are not limited to these number of RATs. Instead, any number of RATs may be included in the network. Also, while embodiments were described above using 3G and LTE as example RATs or 2G/3G/4G as example RATs, the embodiments are applicable to and/or may include additional RATs or any combination of RATs such as 2G, CDMA, WCDMA, EVDO, WiMax, WiFi, etc. Still further, the load balancing profile may include additional levels of RAT scale. For example, preference values for large cell (e.g., macro) and smaller cell (e.g., micro, pico, femto, etc.) may be determined, and used in load balancing performed across cell types in the same manner as described above with respect to RATs. As another example, preference values for particular carriers with a given RAT may be determined, and used in load balancing performed across different carriers of a RAT.

The invention being thus described, it will be obvious that the same may be varied in many ways. Such variations are not to be regarded as a departure from the invention, and all such modifications are intended to be included within the scope of the invention.

We claim:

1. A method of influencing load balancing among a plurality of radio access technologies (RATs), comprising:
transferring, by a network element, a user equipment to a different one of the plurality of RATs based on a load balancing determination and a profile for the user equipment, the profile indicating a preference for each of the plurality of RATs, at least one of the preferences based on at least one attribute of the user equipment monitored over a period of time.

2. The method of claim 1, wherein the transferring comprises:
determining whether to transfer the user equipment to a different one the of plurality or RATs; and
determining the different RAT to which to transfer the user equipment based on the profile if the load balancing determination indicates to pedal in load balancing.

3. The method of claim 1, wherein the attribute is one of bearer usage over the period of time and signaling usage over the period of time.

4. The method of claim 1, wherein at least one of the preferences is based on a cost function, and the cost function is based on the attribute.

5. The method of claim 4, wherein the cost function is based on a plurality of attributes of the user equipment and at least one attribute weight, at least one of the attributes is monitored over the period of time, at least another of the attributes is one of a device type of the user equipment and an application type run by the user equipment.

6. The method of claim 1, wherein at least one of the preferences is accessed from a look-up table using the attribute.

7. The method of claim 1, comprising:
receiving the preferences from a home subscriber server.

8. The method of claim 1, wherein the transferring comprises:
transferring the user equipment to a different carrier based on the profile, wherein the profile further indicates a preference for each of a plurality of carriers in at least the different RAT.

9. The method of claim 1, wherein the network element is a serving base station.

10. The method of claim 9, further comprising:
transferring the load balancing profile from the serving base station to a target base station when the user equipment is handed over to the target base station.

11. The method of claim 1, wherein the attribute is one of bearer usage over the period of time, signaling usage over the period of time, mobility of the user equipment, device type of the user equipment, applications run by the user equipment, application types run by the user equipment, and loading on a control plane.

12. A method of generating a load balancing profile for a user equipment, comprising:
monitoring, at a network element, at least one attribute of a user equipment over a period of time;
generating preference values for the plurality of RATs, at least one of the preference values being based on the monitored attribute; and
generating the load balancing profile based on the generated preference values.

13. The method of claim 12, wherein the monitored attribute is one of bearer usage over the period of time and signaling usage over the period of time.

14. The method of claim 12, wherein the generating preference values generates at least one of the preference values based on a cost function, and wherein the cost function is based on the monitored attribute.

15. The method of claim 14, wherein the cost function is based on a plurality of attributes of the user equipment and at least one attribute weight, at least one of the plurality of attributes is the monitored attribute, and at least another of the plurality of attributes is one of a device type of the user equipment and an application type run by the user equipment.

16. The method of claim 12, wherein the generating preference values generates at least one of the preference values by accessing a look-up table using the monitored attribute.

17. The method of claim 16, wherein the generating preference values classifies the monitored attribute into an attribute level and accesses the look-up table using the attribute level.

18. The method of claim 12, wherein the generating preference values generates preference values for carriers of at least one of the plurality of RATs.

19. The method of claim 12, further comprising:
storing the load balancing profile in a home serving system.

20. The method of claim 19, further comprising:
transferring the load balancing profile to a base station; and
performing, at the base station, load balancing based on the load balancing profile.

21. The method of claim 12, wherein the monitored attribute is one of bearer usage over the period of time, signaling usage over the period of time, mobility of the user equipment, device type of the user equipment, applications run by the user equipment, application types run by the user equipment, and loading on a control plane.

22. A core network element configured to receive at least one attribute of a user equipment monitored over a period of time, and configured to generate preference values for a plurality of radio access technologies (RATs), at least one preference value being based on the received attribute; and
the core network element is configured to generate a load balancing profile based on the generated preference values.

23. The core network element of claim 22, wherein the core network element is a policy and charging rules function configured to generate the load balancing profile based on the generated preference values.

24. The core network element of claim 22, wherein the core network element is a policy and charging rules function configured to generate the load balancing profile by accessing a look-up table using the monitored attribute.
